(19) United States
(12) Patent Application Publication
(10) Pub. No.: US 2012/0288670 A1
(43) Pub. Date: Nov. 15, 2012

(54) FILM CAPABLE OF EMITTING FAR-INFRARED RAYS

(75) Inventors: Tse-Hao Ke, Taipei City (TW); Jui-Hsiang Lin, Taichung City (TW); Yen-Ju Su, Taichung City (TW)

(73) Assignee: BIO-MEDICAL CARBON TECHNOLOGY CO., LTD., Taichung City (TW)

(21) Appl. No.: 13/170,746

(22) Filed: Jun. 28, 2011

(30) Foreign Application Priority Data
May 12, 2011 (TW) 100208532

(51) Int. Cl. B32B 5/02; C09D 1/00; C09J 7/02; C09J 7/04; B32B 3/10; B32B 9/04

(52) U.S. Cl. 428/138; 442/59; 428/221; 428/688; 428/473; 428/408; 428/354; 106/286.8; 106/286.7; 106/286.1; 106/286.6; 106/286.5

(57) ABSTRACT

A film capable of emitting far infrared rays is composed of a surface layer and a carbonic layer coating the surface layer. The carbonic layer includes carbon of at least 60 wt %. When the film is applied to the human skin, the temperature of the skin can be heightened and the blood circulation can be enhanced, so the absorbability of the active ingredients in the film by the human skin can be enhanced. Beside, the film can resist ultraviolet rays to prevent the skin from ultraviolet injury.

### BACKGROUND OF THE INVENTION

1. Field of the Invention

The present invention relates generally to a film, and more particularly, to a film capable of emitting far-infrared rays.

2. Description of the Related Art

In the process of the beauty/body care, it is usually to apply a film soaked in the functional liquid of moisturization, whitening, wrinkle removal, and speck fading for forcing various active ingredients in the functional liquid to penetrate into skin cells for the purpose of skin care and skin improvement to keep the skin in good shape. However, the skin though keeps touching the film full of the functional liquid, but the active ingredients that the skin can absorb are very limited, so the skin care is not effective.

### SUMMARY OF THE INVENTION

The primary objective of the present invention is to provide a film, which can emit far-infrared rays to heighten the temperature of human skin, enhance the absorbability of the active ingredients in the film by the human skin, and function as ultraviolet resistance.

The secondary objective of the present invention is to provide a film, which can emit far-infrared rays and be antibacterial.

The foregoing objectives of the present invention are attained by the film composed of a surface layer and a carbonic layer coating the surface layer. The carbonic layer includes carbon of at least 60 wt %, preferably at least 80 wt %. When the film of the present invention is applied to the human skin, the temperature of the skin can be heightened and the blood circulation can be enhanced, so the absorbability of the active ingredients in the film by the human skin can be enhanced. Beside, the film of the present invention can resist ultraviolet rays to prevent the skin from ultraviolet injury.

### BRIEF DESCRIPTION OF THE DRAWINGS

FIG. 1 is a schematic view of a first preferred embodiment of the present invention.

FIG. 2 is a schematic view of a second preferred embodiment of the present invention.

FIG. 3 is a schematic view of a third preferred embodiment of the present invention.

FIG. 4 is a schematic view of a fourth preferred embodiment of the present invention.

FIG. 5 is an infrared thermographic view showing the temperature distribution before the testee is put on the film of the present invention.

FIG. 6 is an infrared thermographic view showing the temperature distribution of the testee who is put on the film of Example 1.

FIG. 7 is an infrared thermographic view showing the temperature distribution of the testee who is put on the film of Comparative Example 1.

### DETAILED DESCRIPTION OF PREFERRED EMBODIMENTS

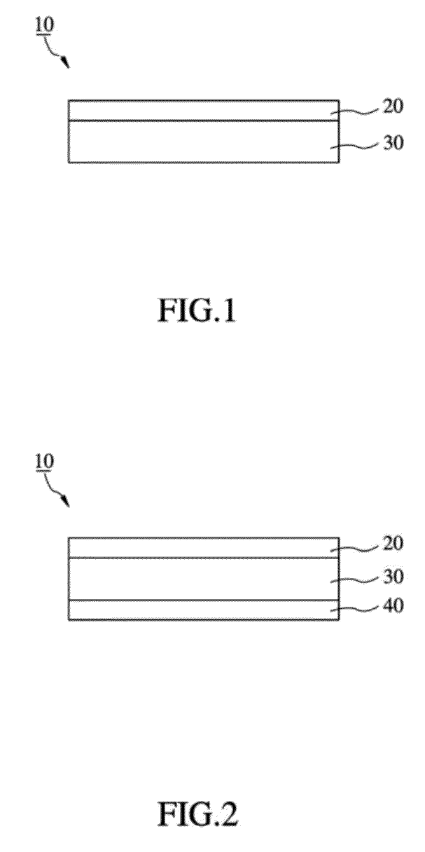

Referring to FIG. 1, a film 10 capable emitting infrared rays in accordance with a first preferred embodiment of the present invention is composed of a surface layer 20 and a carbonic layer 30. The detailed descriptions and operations of these elements as well as their interrelations are recited in the respective paragraphs as follows.

The surface layer 20 is made of natural fiber, artificial fiber, polymer, natural leather, artificial leather, or a composition thereof.

The carbonic layer 30 coats a bottom side of the surface layer 20 and contains carbon of at least 60 wt % and artificial fiber of at most 40 wt %. Preferably, the carbonic layer 30 contains carbon of at least 80 wt % and artificial fiber of at most 20 wt %. The aforesaid carbon can be bamboo charcoal powders, carbon fibers, carbon nanotubes, activated carbon powders, activated carbon grains, activated carbon fibers, or a composition thereof. The carbonic layer 30 can be fabric, nonwoven, paper having vents, or membrane having no vents.

In addition, the carbonic layer 30 of the film 10 in this embodiment further contains metal of at most 2 wt % in the shape of metallic particles or membrane. The metal can be at least one of silver, gold, palladium, copper, zinc, aluminum, and chromium. Therefore, the film 10 can additionally be antibacterial.

In actual production, the film 10 can be added with various functional ingredients, such as hyaluronic acid, collagen, fruit acid, ginkgo extraction, aloe extract, liquorice extraction, tunicin, multi-vitamin, natural moisturizing factor, and algal extraction. When the film 10 is put on the human skin, the carbon in the carbonic layer 30 can emit far infrared rays to heighten the temperature of the skin, enhance the blood circulation, and further increase the absorbability of the functional ingredients for the skin. Besides, the carbon in the carbonic layer 30 can further resist ultraviolet rays to effectively prevent the human skin from the ultraviolet injury. Moreover, the film 10 can be made, as per the actual requirement, into facial mask, brow mask, eye mask, neck mask, chest mask, hand mask, foot mask, scar-removal patch, or wound dressing. The film 10 of the present invention can also be applied to glove, socks, mask, wrist protector, elbow protector, or knee protector.

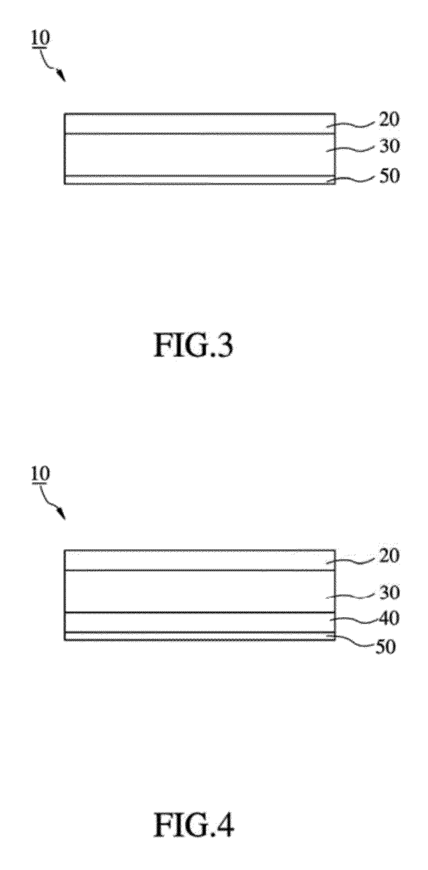

Referring to FIG. 2, the film 10 capable of emitting infrared rays in accordance with a second preferred embodiments of the present invention includes a surface layer 20, a carbonic layer 30, and a bottom layer 40 coating the carbonic layer 30. Referring to FIG. 3, the film 10 capable of emitting infrared rays in accordance with a third preferred embodiments of the present invention includes a surface layer 20, a carbonic layer 30, and a pressure-sensitive adhesive layer 50 coating the carbonic layer 30. Referring to FIG. 4, the film 10 capable of emitting infrared rays in accordance with a fourth preferred embodiments of the present invention includes a surface layer 20, a carbonic layer 30, a bottom layer 40 coating the carbonic layer 30, and a pressure-sensitive adhesive layer 50 coating the bottom layer 40. The bottom layer 40 can be made of natural fiber, artificial fiber, polymer (e.g. polyethylene, polyvinyl chloride, polyethylene terephthalate, Teflon, etc.), natural leather, artificial leather, or the composition thereof. The pressure-sensitive adhesive layer 50 can made of silica gel, acrylic glue, polycarbonate adhesive, or the mixture thereof.

When the film 10 of the second embodiment is applied, the bottom layer 40 touches the human skin. When the films 10 of the third and fourth embodiment are applied, the pressure-sensitive adhesive layer 50 touches the human skin.

The following experimental examples are listed below to specify but not to limit the scope of the present invention. Every change and modification done by the person of ordinary skill in the art can make under the spirit of the present invention fall within the scope of the present invention.

### Example 1

The surface layer 20 is made of PET nonwoven. The carbonic layer 30 is made of fabric of 100% activated carbon fiber, wherein the specific surface area is 1100 m²/g and the moisture content is 19%. The bottom layer 40 is made of porous PE membrane. The surface layer 20, the carbonic layer 30, and the bottom layer 40 are combined with each other by a medical-grade acrylic adhesive to produce the film 10 of the Example 1.

### Example 2

The surface layer 20 is made of cotton cloth. The carbonic layer 30 is formed of felt made of 100% carbon fiber with thickness of 0.2 mm, weight of 70 g/m², specific surface area of 86 m²/g, and moisture content of 0.50%. The pressure-sensitive adhesive layer 50 is formed of silane plastic coated to the carbonic layer 30. The surface layer 20 and the carbonic layer 30 are combined with each other by a medical-grade acrylic adhesive to produce the film 10 of Example 2.

### Example 3

The surface layer 20 is made of cotton cloth. The carbonic layer 30 is formed of cloth made of 100% carbon fiber with specific surface area of 75 m²/g, thickness of 0.35 mm, and weight of 85 g/m². Besides, the carbonic layer 30 contains nanoscale silver granules of 0.2 wt %. All of the layers are combined with each other by a medical-grade acrylic adhesive to produce the film 10 of Example 3.

### Example 4

The surface layer 20 is made of cotton nonwoven. The carbonic layer 30 is formed of nonwoven of mixture of 60 wt % activated carbon fiber and PET fiber with thickness of 0.25 mm, weight of 50 g/m², and specific surface area of 250 m²/g. All of the layers are combined with each other by a medical-grade acrylic adhesive to produce the film 10 of the Example 4.

### Example 5

The surface layer 20 is made of cotton nonwoven. The carbonic layer 30 is made of nonwoven of mixture of 80 wt % activated carbon fiber and PET fiber with thickness of 0.25 mm, weight of 50 g/m², and specific surface area of 400 m²/g. All of the layers are combined with each other by a medical-grade acrylic adhesive to produce the film 10 of the Example 5.

### Comparative Example 1

The surface layer 20 is made of cotton nonwoven. The carbonic layer 30 is made of nonwoven of mixture of 25 wt % activated carbon fiber and PET fiber with thickness of 0.05 mm, weight of 20 g/m², and specific surface area of 100 m²/g. All of the surface and carbonic layers 20 and 30 are combined with each other by a medical-grade acrylic adhesive to produce the film 10 of the Comparative Example 1.

### Comparative Example 2

The surface layer 20 is made of cotton nonwoven. The carbonic layer 30 is made of nonwoven of mixture of 50 wt % activated carbon fiber and PET fiber with thickness of 0.25 mm, weight of 50 g/m², and specific surface area of 200 m²/g. All of the surface and carbonic layers 20 and 30 are combined with each other by a medical-grade acrylic adhesive to produce the film 10 of the Comparative Example 2.

### Comparative Example 3

The surface layer 20 is made of cotton nonwoven. The carbonic layer 30 is made of nonwoven of mixture of 50 wt % activated carbon fiber and PET fiber with thickness of 0.25 mm, weight of 50 g/m², and specific surface area of 200 m²/g. The pressure-sensitive adhesive layer 50 is formed by that silane plastic is directly coated onto the carbonic layer 30. All of the surface and carbonic layers 20 and 30 are combined with each other by a medical-grade acrylic adhesive to produce the film 10 of the Comparative Example 3.

### Method of Test

### [Far-Infrared Test]

First, test the human face, on which the film has not been put, by a thermal infrared-ray digital camera (Model No. SAT-HY6800) to get an average temperature T₁. Next, put the films 10 of the examples and the comparative examples onto the human face for 60 minutes separately and then test the human face by the aforesaid thermal infrared-ray digital camera to get an average temperature T₂ for each of the examples and the comparative examples. T₂ minus T₁ is equal to an incremental value of the average temperature of the human face for each of the examples and the comparative examples as listed in the following Table 1.

TABLE 1

| | Average Temperature |
|---|---|
| Item | of Face (° C.) |
| Example 1 | +1.04 |
| Example 2 | +1.50 |
| Example 3 | +1.56 |
| Example 4 | +0.47 |
| Example 5 | +0.80 |
| Comparative | +0.21 |
| Example 1 | |
| Comparative | +0.25 |
| Example 2 | |
| Comparative | +0.26 |
| Example 3 | |

### [Ultraviolet Resistance Test]

Detect the ultraviolet transmittance and the ultraviolet protection factor (UPF) of the films of the examples and comparative examples by AATCC Test Method 183-2004 and then the detective results are shown in the following Table 2. The ultraviolet transmittance can be indicated by the UVA mean and the UVB mean. As the UVA or UVB mean is lower, the amount of ultraviolet transmittance is less. As the UPF is higher, the ultraviolet resistance is more effective.

TABLE 2

| | | | Ultraviolet |
|---|---|---|---|
| | Ultraviolet Transmittance (%) | | Protection Factor |
| Item | UVA Mean | UVB Mean | (UPF) |
| Example 1 | 0.50 | 0.40 | 230 |
| Example 2 | 0.51 | 0.42 | 220 |
| Example 3 | 0.48 | 0.40 | 235 |
| Example 4 | 10.30 | 10.04 | 15 |
| Example 5 | 3.50 | 3.61 | 29 |
| Comparative | 80.05 | 79.95 | 2 |
| Example 1 | | | |
| Comparative | 40.05 | 40.35 | 5 |
| Example 2 | | | |
| Comparative | 41.30 | 41.5 | 8 |
| Example 3 | | | |

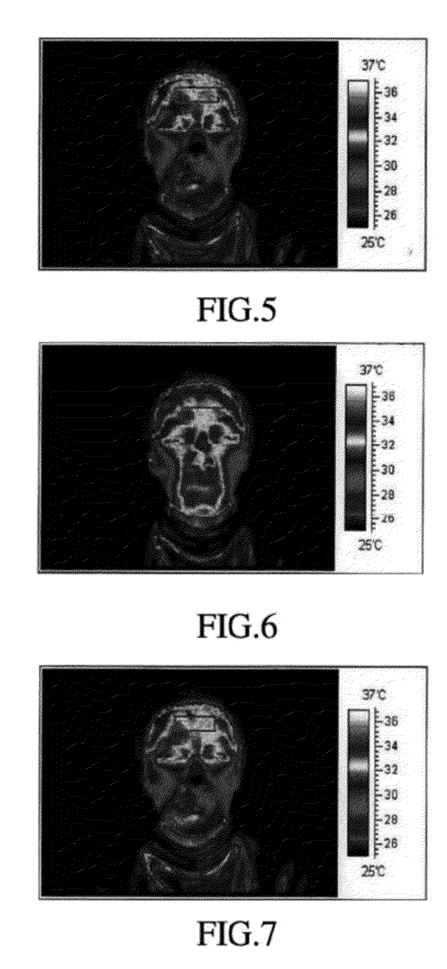

As clearly indicated in the Table 1, after the testee is put on the films of the Examples 1-5 for 60 minutes, the average temperature of the testee's face is obviously heightened; after the testee is put on the films of the Comparative Examples 1-3 for 60 minutes, the average temperature of the testee's face is not obviously changed. Thus, it is demonstrated that the film of the present invention can indeed emit far infrared rays to effectively heighten the temperature where the film is put on to further promote blood circulation. As illustrated in Example 1 and the Comparative Example 1, before the test, when the testee's face has not been put on the film, the temperature distribution detected by the thermal infrared-ray digital camera is shown in FIG. 5; meanwhile, the average temperature of the testee's face is 32.07° C. After the testee's face is put on the films of the Example 1 and the Comparative Example 1 for 60 minutes separately, the temperature distributions detected are shown in FIG. 6-7 to illustrate that the testee's brow, nose, and mouth, who put on the film of the Example 1, are apparently red; meanwhile, the average temperature of the testee's face is 33.11° C., rising for 1.04° C. and the face of the testee put on the film of the Comparative Example 1 does not show any obvious change. Thus, the film of the Example 1 can indeed heighten the average temperature of the testee's face to promote the blood circulation where the film is put on.

In addition, as indicated in the Table 2, the ultraviolet transmittance of the films of the Comparative Examples 1-3 reach 40-80% but the UPF of the same is only 2-8. However, the ultraviolet transmittance of the films of the Examples 1-5 is 0.4-10% only but the UPF of the same reaches 15-235. Thus, it is sufficient to demonstrate that the film of the present invention is very effective in ultraviolet resistance.

In conclusion, when the film of the present invention is applied to the human skin, it can heighten temperature of the skin and promote blood circulation to enhance the absorbability of the active ingredients in the film by the human skin. Besides, the film of the present invention can resist ultraviolet rays to prevent the skin from injury resulting from the ultraviolet rays. Moreover, the film can additionally have antibacterial metal to become antibacterial.

Although the present invention has been described with respect to specific preferred embodiments thereof, it is in no way limited to the specifics of the illustrated structures but changes and modifications may be made within the scope of the appended claims.

What is claimed is:

1. A film capable of emitting far-infrared rays, comprising:
a surface layer; and
a carbonic layer coating the surface layer and having carbon of at least 60 wt %.

2. The film as defined in claim 1, wherein the carbonic layer is made of at least one material selected from a group consisting of bamboo charcoal powders, carbon fibers, carbon nanotubes, activated carbon powders, activated carbon grains, and activated carbon fibers.

3. The film as defined in claim 1, wherein the carbonic layer is a fabric, nonwoven, a paper having vents, or a membrane having none of any vents.

4. The film as defined in claim 1, wherein the carbonic layer further comprises artificial fiber of at most 40 wt %.

5. The film as defined in claim 1, wherein the carbonic layer further comprises metal of at most 2 wt % in the shape of metallic particles or membrane, the metal being selected from a group consisting of silver, gold, palladium, copper, zinc, aluminum, and chromium.

6. The film as defined in claim 1, wherein the carbonic layer comprises carbon of at least 80 wt %.

7. The film as defined in claim 1, wherein the surface layer is made of natural fiber, artificial fiber, polymer, natural leather, artificial leather, or a composition thereof.

8. The film as defined in claim 1 further comprising a bottom layer coating the carbonic layer, wherein the bottom layer is made of natural fiber, artificial fiber, polymer, natural leather, artificial leather, or a composition thereof.

9. The film as defined in claim 8 further comprising a pressure-sensitive adhesive layer coating the bottom layer, wherein the pressure-sensitive adhesive layer is made of silica gel, acrylic glue, polycarbonate adhesive, or the mixture thereof.

10. The film as defined in claim 1 further comprising a pressure-sensitive adhesive layer coating the carbonic layer, wherein the pressure-sensitive adhesive layer is made of silica gel, acrylic glue, polycarbonate adhesive, or the mixture thereof.
